(19) United States
(12) Patent Application Publication
(10) Pub. No.: US 2025/0209601 A1
(43) Pub. Date: Jun. 26, 2025

(54) DEFECT DETECTION SYSTEM AND METHOD USING DEEP NEURAL NETWORK BASED ANALYSIS OF COMPOSITE THERMAL IMAGE DATA

(71) Applicant: INDUSTRY-ACADEMIC COOPERATION FOUNDATION, KUNSAN NATIONAL UNIVERSITY, Gunsan-si (KR)

(72) Inventors: Jackyou NOH, Seoul (KR); Sang Il Lee, Gunsan-si (KR); Hae Myung Chon, Osan-si (KR); Jin Gyun Kim, Gunsan-si (KR)

(21) Appl. No.: 18/984,843

(22) Filed: Dec. 17, 2024

(30) Foreign Application Priority Data
Dec. 21, 2023 (KR) 10-2023-0188706

(51) Int. Cl. G06T 7/00

(52) U.S. Cl. CPC G06T 7/0004; G06T 2207/10048; G06T 2207/20081; G06T 2207/20084; G06T 2207/30108

(57) ABSTRACT

Proposed are a defect detection system and method using deep neural network based analysis of composite thermal image data, wherein considering time-series features of thermal image data of a composite obtained with a thermal imaging camera, the structure of a deep neural network model that can learn is designed, and the model is used to accurately detect fine defects and internal defects of a composite material structure without disassembly thereof.

### CROSS REFERENCE TO RELATED APPLICATION

The present application claims priority to Korean Patent Application No. 10-2023-0188706, filed Dec. 21, 2023, the entire contents of which are incorporated herein for all purposes by this reference.

### BACKGROUND OF THE INVENTION

### Field of the Invention

The present disclosure relates to a defect detection system and method using deep neural network based analysis of composite thermal image data. More particularly, the present disclosure relates to a defect detection system and method using deep neural network based analysis of composite thermal image data, wherein considering time-series features of thermal image data of a composite obtained with a thermal imaging camera, the structure of a deep neural network model that can learn is designed, and the model is used to accurately detect fine defects and internal defects of a composite material structure without disassembly thereof.

### Description of the Related Art

In general, in the management and maintenance of composite material structures in operation, various contact or non-contact methods and developed technologies are applied to detect defects of composites.

Among existing methods for composite defect detection used in the field, visual inspection may identify only defects visible in appearance, and vibration/displacement technology have low resolution, and AE technology have noise issues. In addition, laser UT technology has the difficulty of disassembling a composite material structure and transporting the same to a place where inspection is possible in order to identify defects during operation.

A thermal imaging technique, one of the techniques that can overcome these problems, can detect internal defects, and is non-contact and does not require disassembly of the structure.

However, the thermal imaging technique currently in use has limitations in that the smaller the defect size and the farther away from the heat source, the more difficult it is to detect defects. Therefore, there is a need to develop a technology in which when defect inspection during the operation of a structure is carried out using a thermal imaging technique based on a deep neural network, small-sized defects and defects inside the composite can be detected without disassembly thereof.

The foregoing is intended merely to aid in the understanding of the background of the present disclosure, and is not intended to mean that the present disclosure falls within the purview of the related art that is already known to those skilled in the art.

### SUMMARY OF THE INVENTION

The present disclosure is directed to providing a defect detection system and method using deep neural network based analysis of composite thermal image data, wherein considering time-series features of thermal image data of a composite obtained with a thermal imaging camera, the structure of a deep neural network model that can learn is designed, and the model is used to accurately detect fine defects and internal defects of a composite material structure without disassembly thereof.

According to an embodiment of the present disclosure, there is provided a defect detection system 100 using deep neural network based analysis of composite thermal image data, the defect detection system including: a composite thermal image data learning part 110 configured to learn composite thermal image data to generate a defect detection model; a composite thermal image data feature extraction part 120 configured to use the defect detection model to extract features of input thermal image data of an inspection subject composite; and a composite thermal image data defect determination part 130 configured to determine, on the basis of the extracted features, whether the inspection subject composite has a defect.

In an embodiment, the composite thermal image data learning part 110 may be configured to learn the composite thermal image data on the basis of a deep neural network including a partial thermal gradient feature extraction deep neural network, a thermal gradient time-series feature extraction deep neural network, and a global thermal gradient feature extraction deep neural network.

In an embodiment, the composite thermal image data learning part 110 may be configured to generate multiple particular-sized split sections not overlapping from thermal image data for training, and extract and input a particular split section of the split sections to the partial thermal gradient feature extraction deep neural network to extract multiple feature maps, and input the extracted multiple feature maps to the thermal gradient time-series feature extraction deep neural network.

In an embodiment, the composite thermal image data learning part 110 may be configured to divide the particular split section input to the partial thermal gradient feature extraction deep neural network into multiple patches for input, and learn correlation of temperature gradients between the multiple patches through the partial thermal gradient feature extraction deep neural network.

In an embodiment, the composite thermal image data learning part 110 may be configured to learn, when inputting the multiple feature maps to the thermal gradient time-series feature extraction deep neural network, time-series correlation of temperature changes for a particular period of time for the same split section, and perform feature extraction for a particular period of time for each of the multiple split sections not overlapping to extract multiple feature maps for input to the global thermal gradient feature extraction deep neural network.

In an embodiment, the composite thermal image data learning part 110 may be configured to learn, when inputting the multiple feature maps to the global thermal gradient feature extraction deep neural network, global association of thermal gradient time-series features of each of the split sections for the input multiple feature maps with respect to the thermal image data for training in a full size.

In an embodiment, the composite thermal image data learning part 110 may be configured to learn the global association with respect to the thermal image data for training in the full size through the global thermal gradient feature extraction deep neural network, and transform a total dataset length of the thermal image data for training into a time period and repeat learning for the time period to complete training of the defect detection model.

In an embodiment, the composite thermal image data feature extraction part 120 may be configured to use the defect detection model of which training is completed to extract feature maps of the input thermal image data of the inspection subject composite.

According to another embodiment of the present disclosure, there is provided a defect detection method using deep neural network based analysis of composite thermal image data, the defect detection method including: learning, by a composite thermal image data learning part, composite thermal image data to generate a defect detection model; using, by a composite thermal image data feature extraction part, the defect detection model to extract features of input thermal image data of an inspection subject composite; and determining, on the basis of the extracted features by a composite thermal image data defect determination part, whether the inspection subject composite has a defect.

In an embodiment, the learning of the composite thermal image data to generate the defect detection model may include: generating, by the composite thermal image data learning part, multiple particular-sized split sections not overlapping from thermal image data for training, and extracting and inputting a particular split section of the split sections to a partial thermal gradient feature extraction deep neural network to extract multiple feature maps, and inputting the extracted multiple feature maps to a thermal gradient time-series feature extraction deep neural network; learning, by the composite thermal image data learning part, when inputting the multiple feature maps to the thermal gradient time-series feature extraction deep neural network, time-series correlation of temperature changes for a particular period of time for the same split section, and performing feature extraction for a particular period of time for each of the multiple split sections not overlapping to extract multiple feature maps for input to a global thermal gradient feature extraction deep neural network; and learning, by the composite thermal image data learning part, when inputting the multiple feature maps to the global thermal gradient feature extraction deep neural network, global association of thermal gradient time-series features of each of the split sections for the input multiple feature maps with respect to the thermal image data for training in a full size.

In an embodiment, the inputting of the extracted multiple feature maps to the thermal gradient time-series feature extraction deep neural network may include dividing, by the composite thermal image data learning part, the particular split section input to the partial thermal gradient feature extraction deep neural network into multiple patches for input, and learning correlation of temperature gradients between the multiple patches through the partial thermal gradient feature extraction deep neural network.

In an embodiment, the learning of the global association of the thermal gradient time-series features of each of the split sections for the input multiple feature maps with respect to the thermal image data for training in the full size may include learning, by the composite thermal image data learning part, the global association with respect to the thermal image data for training in the full size through the global thermal gradient feature extraction deep neural network, and transforming a total dataset length of the thermal image data for training into a time period and repeating learning for the time period to complete training of the defect detection model.

According to the present disclosure, fine defects and internal defects can be accurately detected without disassembly of a composite material structure.

In particular, the present disclosure can solve the technical difficulty of the existing thermal imaging technique that when a person detects defects manually with the existing technique, the smaller the defect size and the farther away from the heat source, the more difficult it is to detect defects.

In addition, the present disclosure is used in a device that automatically detects defects of composites, so that automatic detection of defects can be achieved without human intervention and costs and time required for defect detection thus can be dramatically reduced.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a diagram illustrating the configuration of a defect detection system 100 using deep neural network based analysis of composite thermal image data according to an embodiment of the present disclosure;

FIG. 2 is a flowchart illustrating, in sequence, the entire process of learning thermal image data for training by a composite thermal image data learning part 110 to perform and complete training of a defect detection model;

FIG. 3 is a diagram illustrating a split section input to a partial thermal gradient feature extraction deep neural network according to an embodiment of the present disclosure;

FIG. 4 is a diagram illustrating the concept of the partial thermal gradient feature extraction deep neural network of the composite thermal image data learning part 110;

FIG. 5 is a diagram illustrating the concept of a thermal gradient time-series feature extraction deep neural network of the composite thermal image data learning part 110;

FIG. 6 is a diagram illustrating an example in which split sections shown in FIG. 3 are divided without overlapping;

FIG. 7 is a diagram illustrating another example in which split sections shown in FIG. 3 are divided without overlapping;

FIG. 8 is a diagram illustrating another example in which split sections shown in FIG. 3 are divided without overlapping;

FIG. 9 is a diagram illustrating another example in which split sections shown in FIG. 3 are divided without overlapping; and

FIG. 10 is a diagram illustrating the concept of a global thermal gradient feature extraction deep neural network of the composite thermal image data learning part 110.

### DETAILED DESCRIPTION OF THE INVENTION

Hereinafter, the present disclosure will be described in detail with reference to the accompanying drawings.

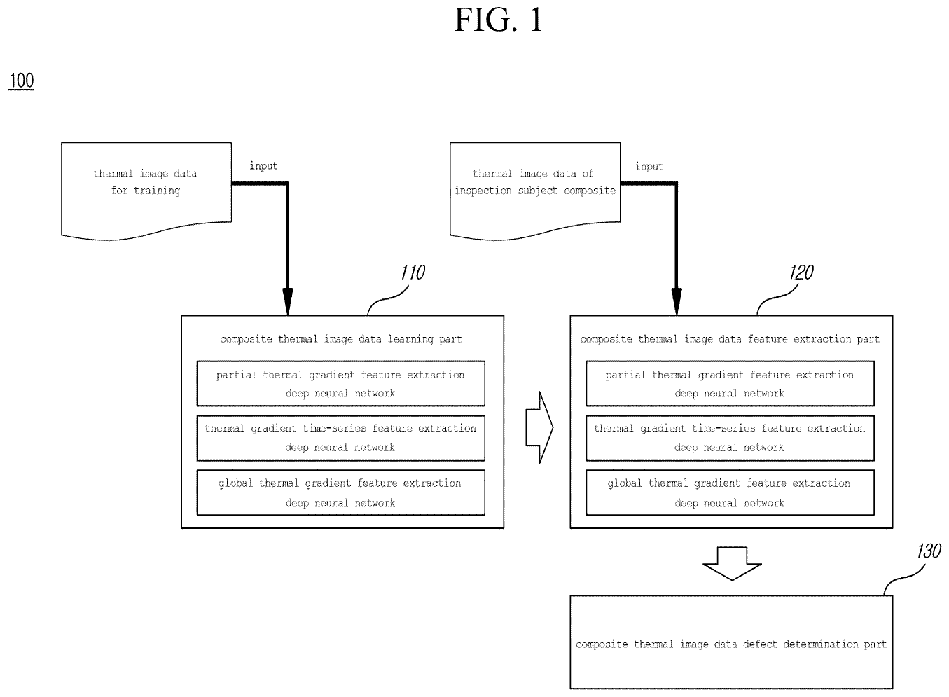

FIG. 1 is a diagram illustrating the configuration of a defect detection system 100 using deep neural network based analysis of composite thermal image data according to an embodiment of the present disclosure.

Referring to FIG. 1, a defect detection system 100 using deep neural network based analysis of composite thermal image data according to an embodiment of the present disclosure may roughly include a composite thermal image data learning part 110, a composite thermal image data feature extraction part 120, and a composite thermal image data defect determination part 130.

First, the composite thermal image data learning part 110 learns composite thermal image data to generate a defect detection model. Herein, thermal image data for training is learned on the basis of a deep neural network including a partial thermal gradient feature extraction deep neural network, a thermal gradient time-series feature extraction deep neural network, and a global thermal gradient feature extraction deep neural network.

A process of learning thermal image data for training by the composite thermal image data learning part 110 to generate a defect detection model is as follows.

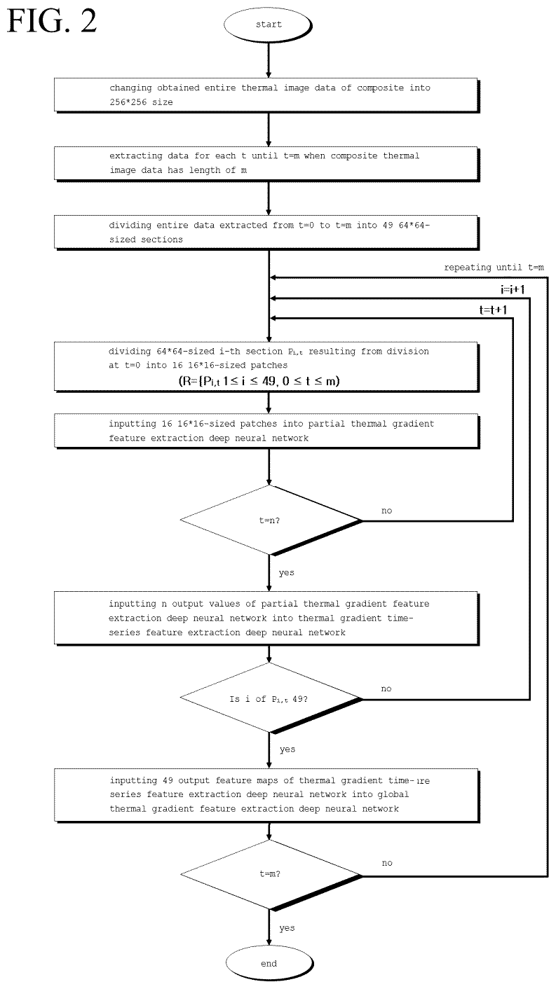

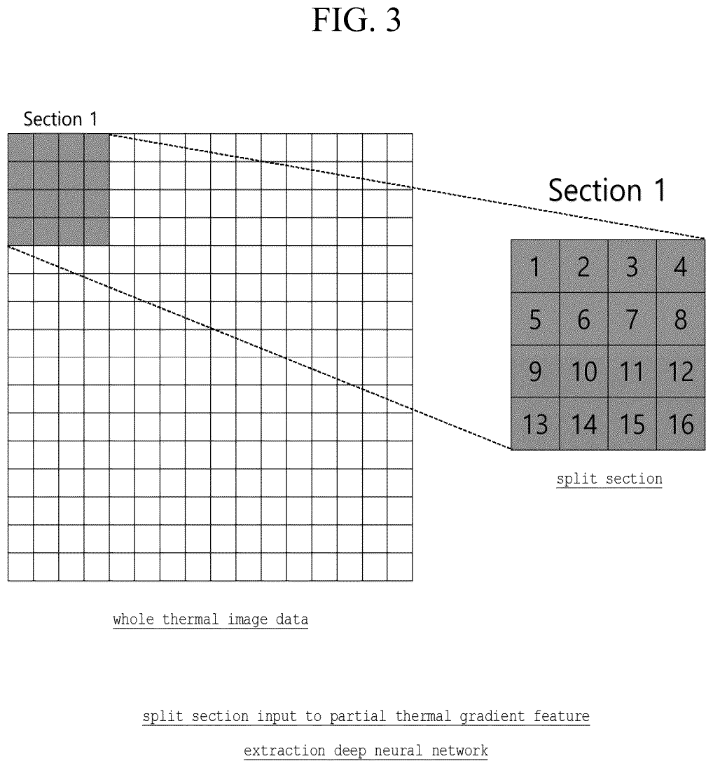

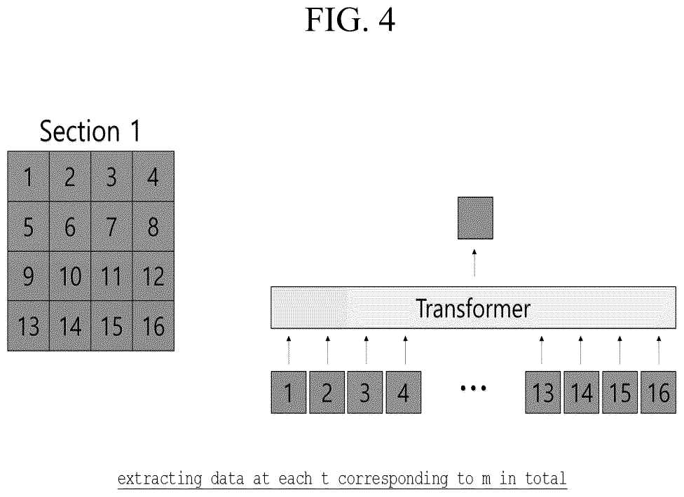

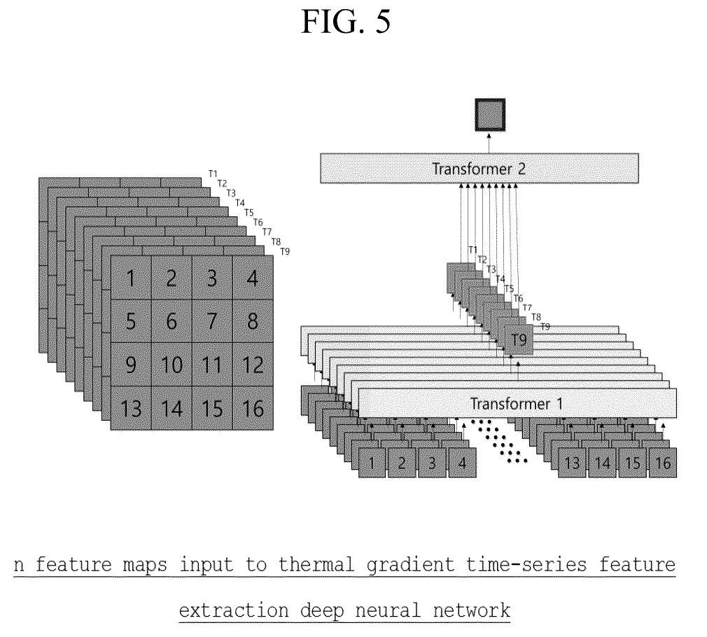

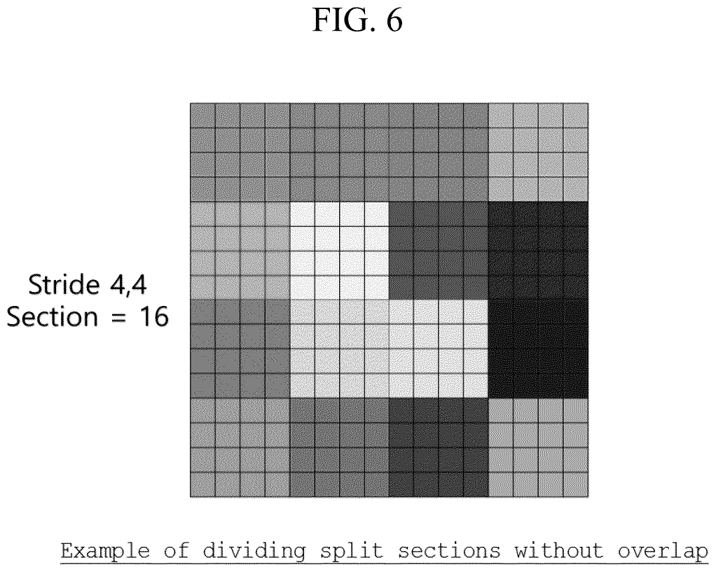

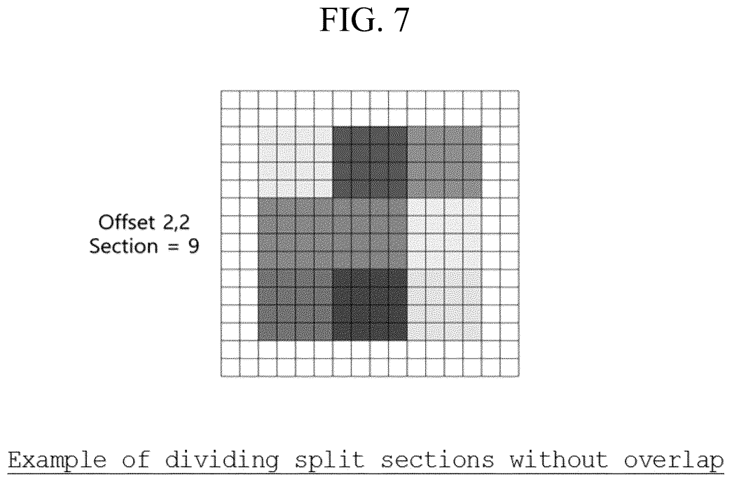

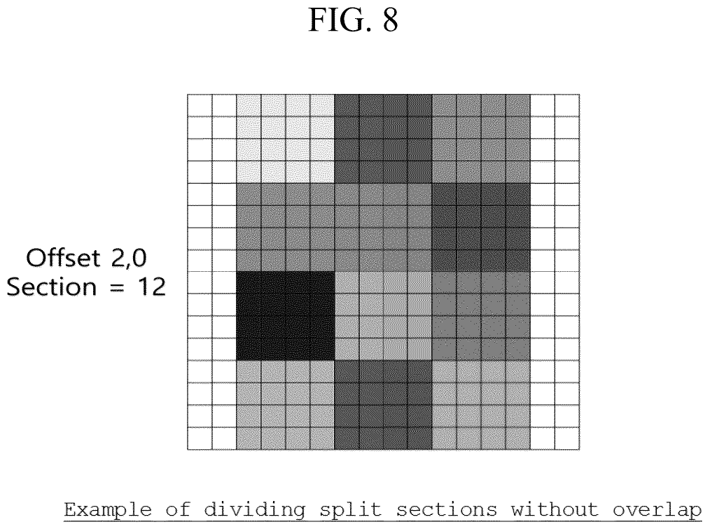

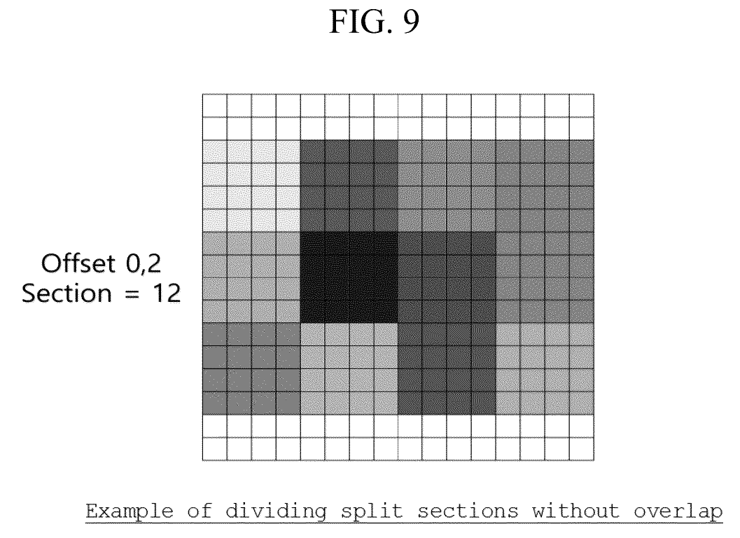

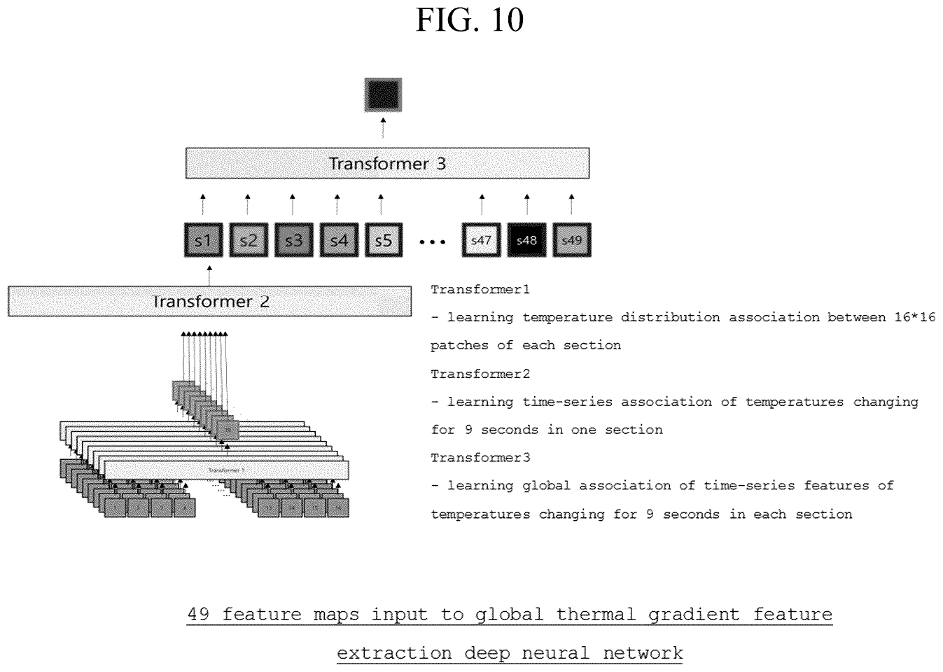

FIG. 2 is a flowchart illustrating, in sequence, the entire process of learning thermal image data for training by the composite thermal image data learning part 110 to perform and complete training of a defect detection model. FIG. 3 is a diagram illustrating a split section input to the partial thermal gradient feature extraction deep neural network according to an embodiment of the present disclosure. FIG. 4 is a diagram illustrating the concept of the partial thermal gradient feature extraction deep neural network of the composite thermal image data learning part 110. FIG. 5 is a diagram illustrating the concept of the thermal gradient time-series feature extraction deep neural network of the composite thermal image data learning part 110. FIG. 6 is a diagram illustrating an example in which split sections shown in FIG. 3 are divided without overlapping. FIG. 7 is a diagram illustrating another example in which split sections shown in FIG. 3 are divided without overlapping. FIG. 8 is a diagram illustrating another example in which split sections shown in FIG. 3 are divided without overlapping. FIG. 9 is a diagram illustrating another example in which split sections shown in FIG. 3 are divided without overlapping. FIG. 10 is a diagram illustrating the concept of the global thermal gradient feature extraction deep neural network of the composite thermal image data learning part 110.

Referring to FIGS. 2 to 10, the composite thermal image data learning part 110 includes a deep neural network including the partial thermal gradient feature extraction deep neural network, the thermal gradient time-series feature extraction deep neural network, and the global thermal gradient feature extraction deep neural network.

Referring to FIGS. 2 to 4, the composite thermal image data learning part 110 extracts 64*64-sized split sections from 256*256-sized thermal image data for training and inputs the same to the partial thermal gradient feature extraction deep neural network. Herein, the total of 49 64*64-sized split sections may be generated without overlapping each other from the whole 256*256-sized thermal image data for training.

Herein, the 64*64-sized split sections generated without overlapping each other from the whole thermal image data for training may be arranged in various ways as shown in FIGS. 6 to 9.

In the meantime, in the process of inputting each of the 64*64-sized split sections to the partial thermal gradient feature extraction deep neural network, the composite thermal image data learning part 110 divides each split section into the total of 16 patches for input. Through this, the partial feature extraction deep neural network may learn the correlation of temperature gradients between the 16 patches, and may extract a feature map accordingly. This is described in more detail as follows.

Assuming that the 256×256-sized thermal image data for training input to the composite thermal image data learning part 110 has the total length of m, the composite thermal image data learning part 110 applies m corresponding to the total length as time t, and extracts data for each time t. Each of the m extracted pieces of 256×256-sized data is divided into 64×64-sized split sections. Herein, the size of each split section is not divided equally as shown in FIGS. 6 to 9.

Referring to FIG. 4, at time t, which is the extraction time point of each 64*64-sized split section, the i-th split section may be denoted as P_{t,i}. When the time is t, the composite thermal image data learning part 110 divides the i-th split section, P_{t,i}, into 16 16*16-sized patches. The partial thermal gradient feature extraction deep neural network inputs this into the thermal gradient feature extraction deep neural network. If the time to be analysed is n, the partial thermal gradient feature extraction deep neural network repeats, from time t to t+n, the process of inputting the i-th split section P_{t,i} divided into 16 patches into the thermal gradient feature extraction deep neural network. By this iterative process, the total of n feature maps are extracted from P_{t,i} to P_{t+n,i}.

The composite thermal image data learning part 110 inputs the total of n feature maps extracted in this way into the thermal gradient time-series feature extraction deep neural network. Herein, as shown in FIG. 5, the composite thermal image data learning part 110 also repeats this process i+1 times from the i-th split section P_{t,i} to P_{i,49}. By repeating this process, the total of 49 feature maps may be extracted from P_{t,1} to P_{t,49}.

The composite thermal image data learning part 110 inputs the 49 feature maps extracted in this way into the global thermal gradient feature extraction deep neural network. Herein, as shown in FIG. 10, the composite thermal image data learning part 110 also repeats this process from P_{t,i} to P_{m,i}.

When all analysis of the thermal image data for training from the time pint t=0 to t=m is completed, the composite thermal image data learning part 110 terminates learning for the defect detection model.

When the composite thermal image data learning part 110 terminates learning, learning parameters of the partial thermal gradient feature extraction deep neural network, the thermal gradient feature extraction deep neural network, and the global thermal gradient feature extraction deep neural network are fixed and the partial thermal gradient feature extraction deep neural network, the thermal gradient feature extraction deep neural network, and the global thermal gradient feature extraction deep neural network of the composite thermal image data feature extraction part 120, which will be described below, are completed.

The composite thermal image data feature extraction part 120 uses the completed defect detection model to extract feature maps from input 256*256-sized thermal image data of an inspection subject composite in the same way as the composite thermal image data learning part 110 previously performed, without changing the learning parameters.

The feature maps extracted by the composite thermal image data feature extraction part 120 are input to the composite thermal image data defect determination part 130. The composite thermal image data defect determination part 130 analyzes m/n feature maps extracted from the entire thermal image data of the inspection subject composite up to time t=m to determine and classify the inspection subject composite as being defective (Defect) or normal (Non-Defect).

Next, the entire process of learning composite thermal image data and determining whether the inspection subject composite has a defect by using the above-described defect detection system 100 using deep neural network-based analysis of composite thermal image data will be described in sequence.

First, the composite thermal image data learning part 110 learns composite thermal image data to generate a defect detection model. In this process, the composite thermal image data learning part 110 extracts 64*64-sized split sections from 256*256-sized thermal image data for training and inputs the split sections to the partial thermal gradient feature extraction deep neural network. Herein, each split section is divided into the total of 16 patches for input. Through this, the partial feature extraction deep neural network may learn the correlation of temperature gradients between the 16 patches, and may extract a feature map accordingly.

Next, the composite thermal image data learning part 110 inputs multiple feature maps extracted in this way into the thermal gradient time-series feature extraction deep neural network, and repeats this process to extract multiple feature maps. The multiple extracted feature maps are input again to the global thermal gradient feature extraction deep neural network, and this process is also repeated multiple times. Herein, multiple times may mean until the entire dataset of the thermal image data for training is learned.

Next, when all analysis of the thermal image data for training from the time pint t=0 to t=m is completed, the composite thermal image data learning part 110 terminates learning for the defect detection model.

When learning is terminated, the learning parameters of the partial thermal gradient feature extraction deep neural network, the thermal gradient feature extraction deep neural network, and the global thermal gradient feature extraction deep neural network are fixed and the partial thermal gradient feature extraction deep neural network, the thermal gradient feature extraction deep neural network, and the global thermal gradient feature extraction deep neural network of the composite thermal image data feature extraction part 120 are completed.

Afterward, when 256*256-sized thermal image data of an inspection subject composite is input, the composite thermal image data feature extraction part 120 extracts feature maps in the same way as the composite thermal image data learning part 110 previously performed, without changing learning parameters, and inputs the extracted feature maps to the composite thermal image data defect determination part 130.

The composite thermal image data defect determination part 130 analyzes m/n feature maps extracted from the entire thermal image data of the inspection subject composite up to time t=m to determine and classify the inspection subject composite as being defective (Defect) or normal (Non-Defect).

Although the present disclosure has been described with reference to the exemplary embodiments, those skilled in the art will appreciate that various modifications and variations can be made in the present disclosure without departing from the spirit or scope of the disclosure described in the appended claims.

What is claimed is:

1. A defect detection system using deep neural network based analysis of composite thermal image data, the defect detection system comprising:
a composite thermal image data learning part (110) configured to learn composite thermal image data to generate a defect detection model;
a composite thermal image data feature extraction part (120) configured to use the defect detection model to extract features of input thermal image data of an inspection subject composite; and
a composite thermal image data defect determination part (130) configured to determine, on the basis of the extracted features, whether the inspection subject composite has a defect.

2. The defect detection system of claim 1, wherein the composite thermal image data learning part (110) is configured to learn the composite thermal image data on the basis of a deep neural network including a partial thermal gradient feature extraction deep neural network, a thermal gradient time-series feature extraction deep neural network, and a global thermal gradient feature extraction deep neural network.

3. The defect detection system of claim 2, wherein the composite thermal image data learning part (110) is configured to generate multiple particular-sized split sections not overlapping from thermal image data for training, and extract and input a particular split section of the split sections to the partial thermal gradient feature extraction deep neural network to extract multiple feature maps, and input the extracted multiple feature maps to the thermal gradient time-series feature extraction deep neural network.

4. The defect detection system of claim 3, wherein the composite thermal image data learning part (110) is configured to divide the particular split section input to the partial thermal gradient feature extraction deep neural network into multiple patches for input, and learn correlation of temperature gradients between the multiple patches through the partial thermal gradient feature extraction deep neural network.

5. The defect detection system of claim 3, wherein the composite thermal image data learning part (110) is configured to learn, when inputting the multiple feature maps to the thermal gradient time-series feature extraction deep neural network, time-series correlation of temperature changes for a particular period of time for the same split section, and perform feature extraction for a particular period of time for each of the multiple split sections not overlapping to extract multiple feature maps for input to the global thermal gradient feature extraction deep neural network.

6. The defect detection system of claim 3, wherein the composite thermal image data learning part (110) is configured to learn, when inputting the multiple feature maps to the global thermal gradient feature extraction deep neural network, global association of thermal gradient time-series features of each of the split sections for the input multiple feature maps with respect to the thermal image data for training in a full size.

7. The defect detection system of claim 6, wherein the composite thermal image data learning part (110) is configured to
learn the global association with respect to the thermal image data for training in the full size through the global thermal gradient feature extraction deep neural network, and
transform a total dataset length of the thermal image data for training into a time period and repeat learning for the time period to complete training of the defect detection model.

8. The defect detection system of claim 7, wherein the composite thermal image data feature extraction part (120) is configured to use the defect detection model of which training is completed to extract feature maps of the input thermal image data of the inspection subject composite.

9. A defect detection method using deep neural network based analysis of composite thermal image data, the defect detection method comprising:
learning, by a composite thermal image data learning part, composite thermal image data to generate a defect detection model;
using, by a composite thermal image data feature extraction part, the defect detection model to extract features of input thermal image data of an inspection subject composite; and
determining, on the basis of the extracted features by a composite thermal image data defect determination part, whether the inspection subject composite has a defect.

10. The defect detection method of claim 9, wherein the learning of the composite thermal image data to generate the defect detection model comprises:
generating, by the composite thermal image data learning part, multiple particular-sized split sections not overlapping from thermal image data for training, and extracting and inputting a particular split section of the split sections to a partial thermal gradient feature extraction deep neural network to extract multiple feature maps, and inputting the extracted multiple feature maps to a thermal gradient time-series feature extraction deep neural network;
learning, by the composite thermal image data learning part, when inputting the multiple feature maps to the thermal gradient time-series feature extraction deep neural network, time-series correlation of temperature changes for a particular period of time for the same split section, and performing feature extraction for a particular period of time for each of the multiple split sections not overlapping to extract multiple feature maps for input to a global thermal gradient feature extraction deep neural network; and
learning, by the composite thermal image data learning part, when inputting the multiple feature maps to the global thermal gradient feature extraction deep neural network, global association of thermal gradient time-series features of each of the split sections for the input multiple feature maps with respect to the thermal image data for training in a full size.

11. The defect detection method of claim 10, wherein the inputting of the extracted multiple feature maps to the thermal gradient time-series feature extraction deep neural network comprises:
dividing, by the composite thermal image data learning part, the particular split section input to the partial thermal gradient feature extraction deep neural network into multiple patches for input, and learning correlation of temperature gradients between the multiple patches through the partial thermal gradient feature extraction deep neural network.

12. The defect detection method of claim 10, wherein the learning of the global association of the thermal gradient time-series features of each of the split sections for the input multiple feature maps with respect to the thermal image data for training in the full size comprises:
learning, by the composite thermal image data learning part, the global association with respect to the thermal image data for training in the full size through the global thermal gradient feature extraction deep neural network, and transforming a total dataset length of the thermal image data for training into a time period and repeating learning for the time period to complete training of the defect detection model.
